(19) United States
(12) Patent Application Publication
(10) Pub. No.: US 2023/0237731 A1
(43) Pub. Date: Jul. 27, 2023

(54) SCALABLE PARALLAX SYSTEM FOR RENDERING DISTANT AVATARS, ENVIRONMENTS, AND DYNAMIC OBJECTS

(71) Applicant: Meta Platforms Technologies, LLC, Menlo Park, CA (US)

(72) Inventor: Eric Harvard Cosky, Redwood City, CA (US)

(21) Appl. No.: 17/586,576

(22) Filed: Jan. 27, 2022

(51) Int. Cl. G06T 15/20; G06T 13/40; H04S 7/00

(52) U.S. Cl. CPC G06T 15/20; G06T 13/40; H04S 7/30; H04S 2400/11; H04L 65/4069

(57) ABSTRACT

Methods, systems, and storage media for rendering digital environments are disclosed. Exemplary implementations may: receive a data stream at an area rendering server; render, by the area rendering server, a global digital environment based at least in part on the received data stream; generate a parallax rendering data stream based at least in part on the received data stream; receive the parallax rendering data stream at a composition server; combine, by the composition server, the received parallax rendering data stream into a new parallax rendering data stream; render, by one or more client platforms, a local digital environment based at least in part on the new parallax rendering data stream; and cause display of the local digital environment through an output of the one or more client platforms.

### TECHNICAL FIELD

The present disclosure generally relates to rendering digital environments and more particularly to scalable parallax system for rendering distant avatars, environments, and dynamic objects.

### BACKGROUND

Conventionally, artificial reality environments or “digital environments” include virtual reality, augmented reality, mixed reality, and/or other artificial reality environments. Virtual reality or “VR,” as used herein, refers to an immersive experience where a user's visual input is controlled by a computing system. Augmented reality or “AR” refers to systems where a user views images of the real-world after they have passed through a computing system. which can process and adjust or “augment” the images as they passthrough the system, such as by adding virtual objects. Mixed reality or “MR” refers to systems where light entering a user's eye is partially generated by a computing system and partially composes light reflected off objects in the real-world.

### BRIEF SUMMARY

The subject disclosure provides for systems and methods for rendering digital environments. A user is provided with experiences in digital environments with large quantities (e.g., hundreds, thousands, millions, etc.) of other live users. For example, an avatar associated with a given user can interact with other avatars in its immediate vicinity within a digital environment. The given user's avatar may be able to observe or “see” many of the large quantities of other avatars at a distance (or through some barrier) but not necessarily interact directly with them. One example may include a digital environment simulating a stadium experience in which the given user's avatar is located in a box suite and can interact with avatars there but only see other avatars in adjacent box suites and avatars in stadium seats throughout portions for the stadium.

One aspect of the present disclosure relates to a method for rendering digital environments. The method may include receiving a data stream at an area rendering server. The method may include rendering, by the area rendering server, a global digital environment based at least in part on the received data stream. The method may include generating a parallax rendering data stream based at least in part on the received data stream. The method may include receiving the parallax rendering data stream at a composition server. The method may include combining, by the composition server, the received parallax rendering data stream into a new parallax rendering data stream. The method may include rendering, by one or more client platforms, a local digital environment based at least in part on the new parallax rendering data stream. The method may include causing display of the local digital environment through an output of the one or more client platforms.

Another aspect of the present disclosure relates to a system configured for rendering digital environments. The system may include one or more hardware processors configured by machine-readable instructions. The processor(s) may be configured to receive a data stream at an area rendering server. The processor(s) may be configured to render, by the area rendering server, a global digital environment based at least in part on the received data stream. The global environment may include animated avatars and/or dynamic objects. The processor(s) may be configured to generate a parallax rendering data stream based at least in part on the received data stream. The processor(s) may be configured to render, by the area rendering server, an audio stream for the global digital environment. The processor(s) may be configured to receive the parallax rendering data stream and the audio stream at a composition server. The processor(s) may be configured to combine, by the composition server, the received parallax rendering data stream and the audio stream into a new parallax rendering data stream. The processor(s) may be configured to render, by one or more client platforms, a local digital environment based at least in part on the new parallax rendering data stream. The processor(s) may be configured to cause display of the local digital environment through an output of the one or more client platforms.

Yet another aspect of the present disclosure relates to a non-transient computer-readable storage medium having instructions embodied thereon, the instructions being executable by one or more processors to perform a method for rendering digital environments. The method may include receiving a data stream at an area rendering server. The method may include rendering, by the area rendering server, a global digital environment based at least in part on the received data stream. The global digital environment may include a stadium. The global environment may include animated avatars and/or dynamic objects. The method may include generating a parallax rendering data stream based at least in part on the received data stream. The method may include rendering, by the area rendering server, an audio stream for the global digital environment. The method may include receiving the parallax rendering data stream and the audio stream at a composition server. The method may include combining, by the composition server, the received parallax rendering data stream and the audio stream into a new parallax rendering data stream. The method may include providing multiple versions of the new parallax rendering data stream to one or more client platforms. The method may include rendering, by the one or more client platforms, a local digital environment based at least in part on the new parallax rendering data stream. The method may include causing display of the local digital environment through an output of the one or more client platforms.

Still another aspect of the present disclosure relates to a system configured for rendering digital environments. The system may include means for receiving a data stream at an area rendering server. The system may include means for rendering, by the area rendering server, a global digital environment based at least in part on the received data stream. The system may include means for generating a parallax rendering data stream based at least in part on the received data stream. The system may include means for receiving the parallax rendering data stream at a composition server. The system may include means for combining, by the composition server, the received parallax rendering data stream into a new parallax rendering data stream. The system may include means for rendering, by one or more client platforms, a local digital environment based at least in part on the new parallax rendering data stream. The system may include means for causing display of the local digital environment through an output of the one or more client platforms.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIGS. 1A and 1B illustrates a scalable parallax system configured for rendering distant avatars, environments, and dynamic objects, according to certain aspects of the disclosure.

FIGS. 2A and 2B illustrate example views of digital environments provided by the scalable parallax system of FIGS. 1A and 1B in which distant avatars, environments, and dynamic objects are rendered, according to certain aspects of the disclosure.

FIG. 3 is a block diagram illustrating an overview of client devices on which some implementations of the disclosed technology can operate.

FIGS. 4A and 4B are wire diagrams of virtual reality head-mounted displays (HMDs) and related components, according to certain aspects of the disclosure.

FIG. 5 illustrates a system configured for rendering digital environments, in accordance with one or more implementations.

FIG. 6 illustrates an example flow diagram for rendering digital environments, according to certain aspects of the disclosure.

FIG. 7 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

In conventional artificial reality technologies, representing a large event or sporting arena with massive crowds is not feasible due to constraints on computation power, communication bandwidth, and other technical limitations. For example, existing systems cannot realistically generate artificial reality environments with representations (e.g., avatars) of thousands of people on the same server, rendered individually on every client.

The subject disclosure provides for systems and methods for rendering digital environments. A user is provided with experiences in digital environments with large quantities (e.g., hundreds, thousands, millions, etc.) of other live users. For example, an avatar associated with a given user can interact with other avatars in its immediate vicinity within a digital environment. The given user's avatar may be able to observe or “see” many of the large quantities of other avatars at a distance (or through some barrier) but not necessarily interact directly with them. One example may include a digital environment simulating a stadium experience in which the given user's avatar is located in a box suite and can interact with avatars there but only see other avatars in adjacent box suites and avatars in stadium seats throughout portions for the stadium.

Implementations described herein address the aforementioned shortcomings and other shortcomings by individually rendering any number of areas containing avatars within digital environments containing dynamic objects, combining the resulting visuals together, and providing the results as a collection of video streams and/or geometry data streams that can be accessed on-demand by any viewer, which are then used as perspective-aware materials by a rendering technique that uses a hybrid of local and cloud rendered imagery and/or geometry. In exemplary implementations, the results may be used to produce an effective representation of any number of avatars and environments.

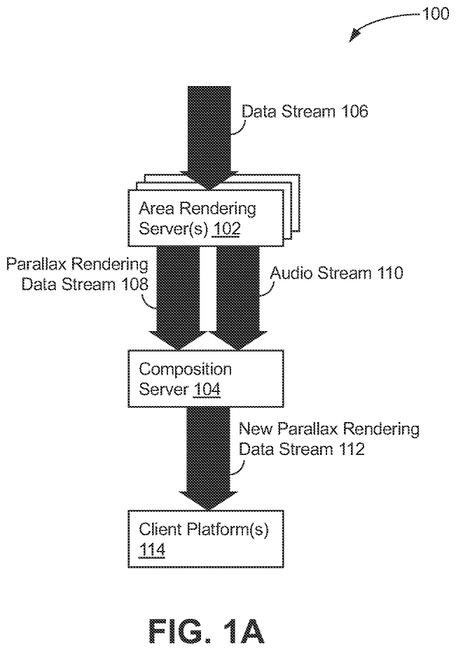

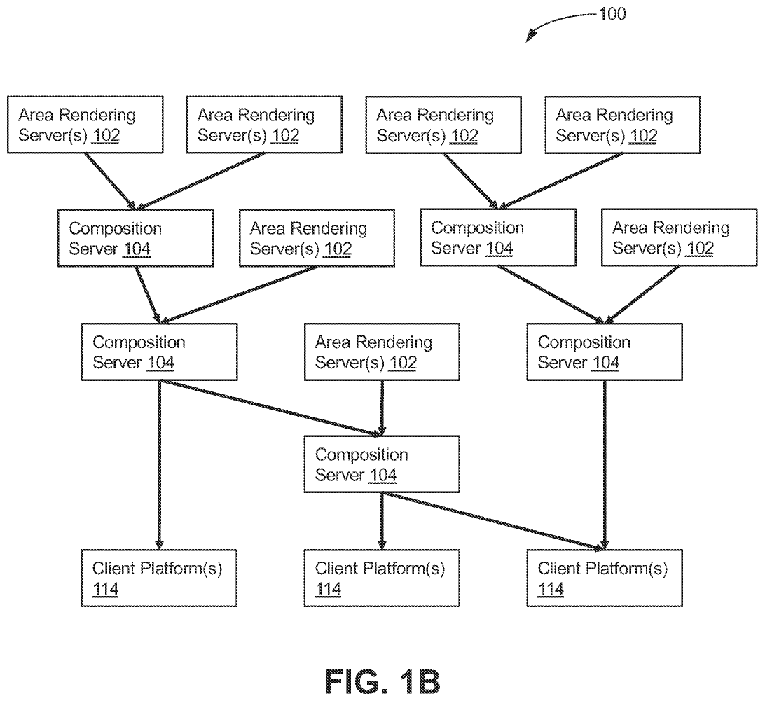

FIGS. 1A and 1B illustrates a scalable parallax system 100 configured for rendering distant avatars, environments, and dynamic objects, according to certain aspects of the disclosure. As depicted in FIGS. 1A and 1B, the scalable parallax system 100 may include one or more of multiple area rendering servers 102, a composition server 104, and/or other components.

The multiple area rendering servers 102 may be configured to receive a data stream 106 including data (e.g., visual, geometry, and audio data) associated with a digital environment comprising a global digital environment containing a plurality of local digital environments. The data stream 106 may be received from any number of sources for data associated with digital environments. The multiple area rendering servers 102 may be configured to render the global digital environment based at least in part on the received data stream 106. The multiple area rendering servers 102 may be configured to generate a parallax rendering data stream 108 based at least in part on the received data stream 106. The multiple area rendering servers 102 may be configured to render an audio stream 110 for the global digital environment.

A given parallax rendering data stream may include one or more bitmaps. Examples of such bitmaps may include one or more of depth maps, normal maps, color maps, and/or other bitmaps. In some implementations, the given parallax rendering data stream may include geometry used to position objects relative to each other. By way of non-limiting illustration, a parallax rendering data stream may represent a room where a portion of the data is used to represent an avatar at an arbitrary position within the room. Additional geometry may include one or more flat polygons drawn at a position relative to the room, using additional material data used by the walls of the room. There may be any number of such polygons in the room. The material data used for these polygons may be embedded in the same materials used by the room to improve performance and reduce network bandwidth.

The composition server 104 may be configured to receive the parallax rendering data stream 108 and/or the audio stream 110. The composition server 104 may be configured to combine the received parallax rendering data stream 108 and/or the audio stream into a new parallax rendering data stream 112. Individual client platform(s) 114 may be configured to render the local digital environment based at least in part on the new parallax rendering data stream 112. The local digital environment may be displayed through an output of the one or more client platforms 114. FIG. 1B illustrates how scalable parallax system 100 can scale to merge any number tiers into single data streams.

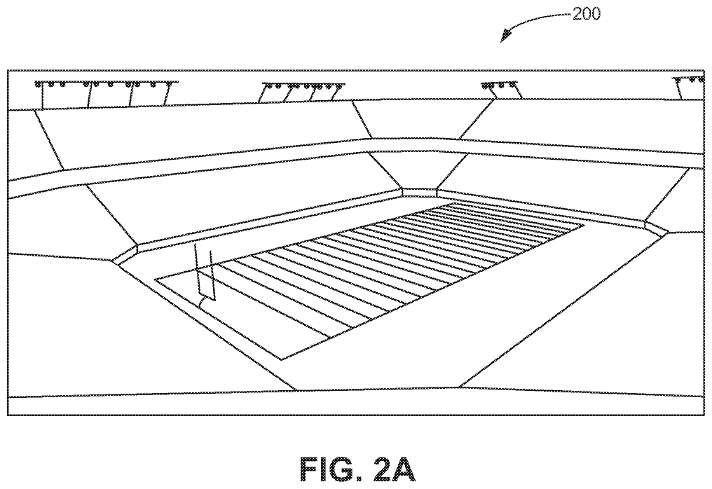

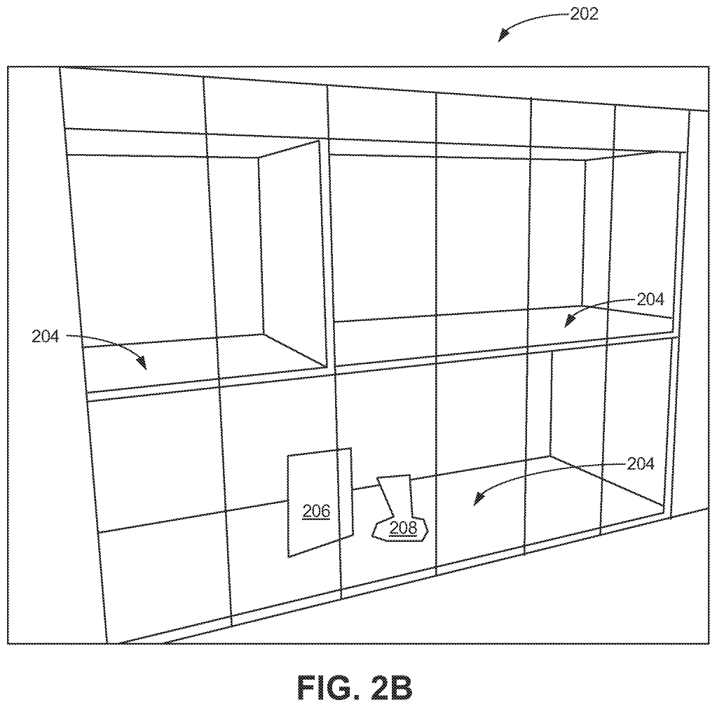

FIGS. 2A and 2B illustrate example views of digital environments 200 and 202, respectively provided by the scalable parallax system 100 of FIGS. 1A and 1B in which distant avatars, environments, and dynamic objects are rendered, according to certain aspects of the disclosure. In exemplary implementations, a group of avatars may be able to interact in a small area, like a private box at a sporting event (e.g., at the stadium depicted by digital environment 200 in FIG. 2A) where none of the avatars in adjacent boxes can directly interact with each other and only see other avatars at some distance (e.g., across the stadium). Each of these rooms, and all their occupants, can be rendered into a set of materials with depth, which can be reprojected to lend a sense of perspective and depth if viewed from sufficient distances and within specific view angles. As used herein, the term “material” may be used to include a combination of one or more bitmaps and one or more shader programs which can be used to produce one or more bitmaps that are the result of a render process that incorporates the materials and polygonal geometry.

The multiple area rendering servers 102 of FIGS. 1A and 1B may create the individual room materials by rendering the local environment and all animated avatars, using the same data stream individual devices receive from each other to track the movements of avatars and other dynamic objects. In addition to generating the parallax rendering data stream, the multiple area rendering servers 102 may render an audio stream that exists in the area and make it available as part of the processing for an area. Depending on the area's visibility within the overall environment, it may be necessary to configure and render multiple parallax streams to support views from significantly different angles.

Various streams described herein may include a geometry stream, which may be used to represent objects within a volume (e.g., separate from walls of the volume). The geometry stream may facilitate both stationary and moving objects to be rendered as simplified flat polygonal shapes at arbitrary positions relative to the volume. This may increase or enhance a sense of depth and parallax as a result of these polygonal shapes occluding each other and the environment within the volume.

The parallax rendering data stream and audio may be sent to the composition server 104 of FIGS. 1A and 1B, which may combine some number of these into a sequence of material atlases and spatialized audio stream(s) that are accessible to remote clients. There may be practical limits to how many streams can be processed by a single server, so there may be rules that control this behavior allowing physically adjacent clusters to be packed together to reduce the number of streams necessary to reproduce clusters of individual areas in the resulting material atlas sequence. This clustering approach may be stacked, allowing clusters of clusters to be generated, repeatedly, to merge any number of areas into a single stream. The only limitation might be the resolution of the final materials, which may be tuned to never exceed the texel density of the final display surfaces of the client devices. The composition server 104 may provide access to multiple versions of the streams so that each client platform 114 can request a version of the data most suited for the viewing distance and screen resolution.

The atlas material sequence may then be used by client platform(s) 114 to render the composition of all visible viewer areas outside their own space, which may be continually rendered. In a sufficiently large environment, there may be multiple area rendering servers in operation. Client platform(s) 114 may use their own visibility rules to determine if and/or when to connect to individual area rendering servers to retrieve the current stream materials representing a cluster of visible areas. Each visible area on the client may have positional data in addition to other metadata that will be sent to an “area dispatcher” service which may provide the necessary connection information for connecting to the correct area composition services in order to retrieve the necessary parallax rendering data streams.

FIG. 2B illustrates three different areas in a digital environment that could each contain a fully populated room 204 (e.g., with avatars 206 and/or dynamic objects 208). Each of the rooms 204 may be rendered at the highest possible quality for the individuals in each room however to an outside observer some distance away (like the perspective shown). Information associated with the rooms 204 may be received as a data stream of one to three parallax materials. While FIG. 2B depicts only a few rooms 204, this technique may scale to show any number of individual areas filled with avatars and dynamic objects. For instance, an entire side of a high-rise, with ten rooms across and twenty floors high, may be provided such that each room is filled with the maximum number of avatars that are possible to render in real-time in an interactive space. Since none of the rooms are visible to each other, avatars in each room would have high performance and framerate. Individual avatars may see across a street to another building that is showing another two hundred rooms with everything that is going on inside them, as a result of multiple area renderers feeding their parallax streams into an area compositor that each individual on the other side of the street is streaming down as a single parallax rendering data stream.

Embodiments of the disclosed technology may include or be implemented in conjunction with an artificial reality system. Artificial reality, extended reality, or extra reality (collectively “XR”) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real-world after they have passed through a computing system. For example, a tablet with a camera on the back can capture images of the real-world and then display the images on the screen on the opposite side of the tablet from the camera. The tablet can process and adjust or “augment” the images as they passthrough the system, such as by adding virtual objects. “Mixed reality” or “MR” refers to systems where light entering a user's eye is partially generated by a computing system and partially composes light reflected off objects in the real-world. For example, a MR headset could be shaped as a pair of glasses with a pass-through display, which allows light from the real-world to passthrough a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

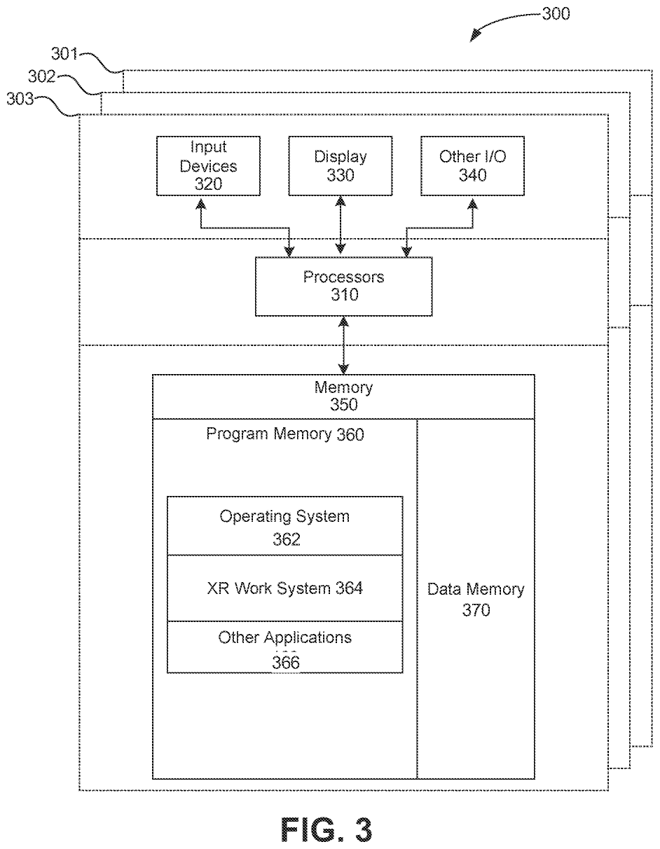

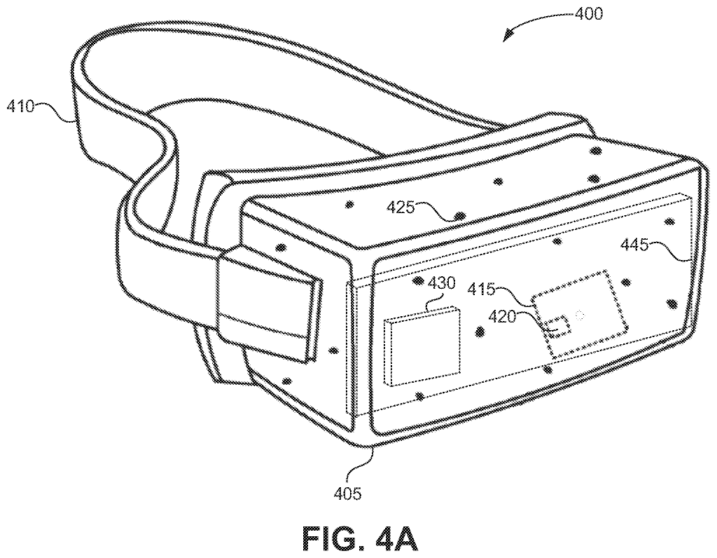

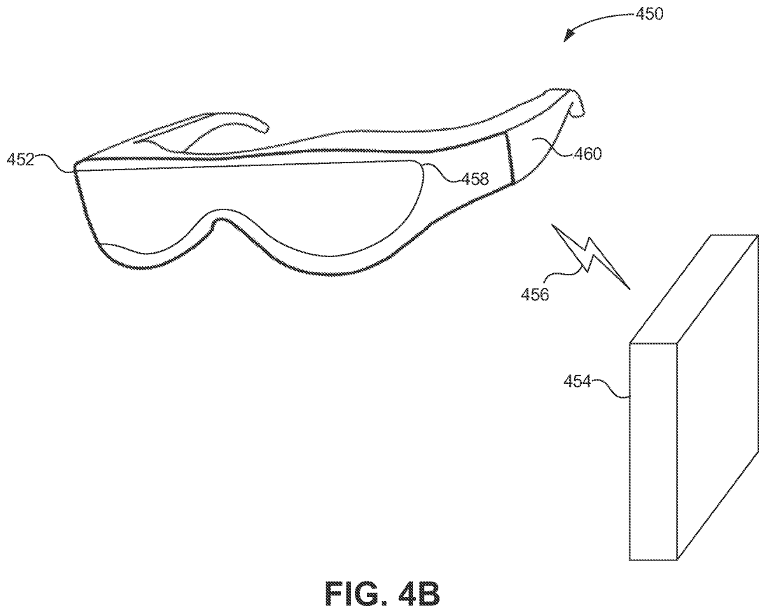

Several implementations are discussed below in more detail in reference to the figures. FIG. 3 is a block diagram illustrating an overview of devices on which some implementations of the disclosed technology can operate. The devices can comprise hardware components of a computing system 300 that can create, administer, and provide interaction modes for an artificial reality collaborative working environment. In various implementations, computing system 300 can include a single computing device 303 or multiple computing devices (e.g., computing device 301, computing device 302, and computing device 303) that communicate over wired or wireless channels to distribute processing and share input data. In some implementations, computing system 300 can include a stand-alone headset capable of providing a computer created or augmented experience for a user without the need for external processing or sensors. In other implementations, computing system 300 can include multiple computing devices such as a headset and a core processing component (such as a console, mobile device, or server system) where some processing operations are performed on the headset and others are offloaded to the core processing component. Example headsets are described below in relation to FIGS. 4A and 4B. In some implementations, position and environment data can be gathered only by sensors incorporated in the headset device, while in other implementations one or more of the non-headset computing devices can include sensor components that can track environment or position data.

Computing system 300 can include one or more processor(s) 310 (e.g., central processing units (CPUs), graphical processing units (GPUs), holographic processing units (HPUs), etc.) Processors 310 can be a single processing unit or multiple processing units in a device or distributed across multiple devices (e.g., distributed across two or more of computing devices 301-103).

Computing system 300 can include one or more input devices 320 that provide input to the processors 310, notifying them of actions. The actions can be mediated by a hardware controller that interprets the signals received from the input device and communicates the information to the processors 310 using a communication protocol. Each input device 320 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 310 can be coupled to other hardware devices, for example, with the use of an internal or external bus, such as a PCI bus, SCSI bus, or wireless connection. The processors 310 can communicate with a hardware controller for devices, such as for a display 330. Display 330 can be used to display text and graphics. In some implementations, display 330 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 340 can also be coupled to the processor, such as a network chip or card, video chip or card, audio chip or card, USB, firewire or other external device, camera, printer, speakers, CD-ROM drive, DVD drive, disk drive, etc.

Computing system 300 can include a communication device capable of communicating wirelessly or wire-based with other local computing devices or a network node. The communication device can communicate with another device or a server through a network using, for example, TCP/IP protocols. Computing system 300 can utilize the communication device to distribute operations across multiple network devices.

The processors 310 can have access to a memory 350, which can be contained on one of the computing devices of computing system 300 or can be distributed across of the multiple computing devices of computing system 300 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 350 can include program memory 360 that stores programs and software, such as an operating system 362, XR work system 364, and other application programs 366. Memory 350 can also include data memory 370 that can include information to be provided to the program memory 360 or any element of the computing system 300.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 4A is a wire diagram of a virtual reality head-mounted display (HMD) 400, in accordance with some embodiments. The HMD 400 includes a front rigid body 405 and a band 410. The front rigid body 405 includes one or more electronic display elements of an electronic display 445, an inertial motion unit (IMU) 415, one or more position sensors 420, locators 425, and one or more compute units 430. The position sensors 420, the IMU 415, and compute units 430 may be internal to the HMD 400 and may not be visible to the user. In various implementations, the IMU 415, position sensors 420, and locators 425 can track movement and location of the HMD 400 in the real-world and in a virtual environment in three degrees of freedom (3 DoF) or six degrees of freedom (6 DoF). For example, the locators 425 can emit infrared light beams which create light points on real objects around the HMD 400. As another example, the IMU 415 can include e.g., one or more accelerometers, gyroscopes, magnetometers, other non-camera-based position, force, or orientation sensors, or combinations thereof. One or more cameras (not shown) integrated with the HMD 400 can detect the light points. Compute units 430 in the HMD 400 can use the detected light points to extrapolate position and movement of the HMD 400 as well as to identify the shape and position of the real objects surrounding the HMD 400.

The electronic display 445 can be integrated with the front rigid body 405 and can provide image light to a user as dictated by the compute units 430. In various embodiments, the electronic display 445 can be a single electronic display or multiple electronic displays (e.g., a display for each user eye). Examples of the electronic display 445 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 400 can be coupled to a core processing component such as a personal computer (PC) (not shown) and/or one or more external sensors (not shown). The external sensors can monitor the HMD 400 (e.g., via light emitted from the HMD 400) which the PC can use, in combination with output from the IMU 415 and position sensors 420, to determine the location and movement of the HMD 400.

FIG. 4B is a wire diagram of a mixed reality HMD system 450 which includes a mixed reality HMD 452 and a core processing component 454. The mixed reality HMD 452 and the core processing component 454 can communicate via a wireless connection (e.g., a 60 GHz link) as indicated by link 456. In other implementations, the mixed reality system 450 includes a headset only, without an external compute device or includes other wired or wireless connections between the mixed reality HMD 452 and the core processing component 454. The mixed reality HMD 452 includes a pass-through display 458 and a frame 460. The frame 460 can house various electronic components (not shown) such as light projectors (e.g., LASERs, LEDs, etc.), cameras, eye-tracking sensors, MEMS components, networking components, etc.

The projectors can be coupled to the pass-through display 458, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 454 via link 456 to HMD 452. Controllers in the HMD 452 can convert the image data into light pulses from the projectors, which can be transmitted via the optical elements as output light to the user's eye. The output light can mix with light that passes through the display 458, allowing the output light to present virtual objects that appear as if they exist in the real-world.

Similarly to the HMD 400, the HMD system 450 can also include motion and position tracking units, cameras, light sources, etc., which allow the HMD system 450 to, e.g., track itself in 3 DoF or 6 DoF, track portions of the user (e.g., hands, feet, head, or other body parts), map virtual objects to appear as stationary as the HMD 452 moves, and have virtual objects react to gestures and other real-world objects.

The disclosed system(s) address a problem in traditional digital environment rendering techniques tied to computer technology, namely, the technical problem of new parallax rendering data streams for large quantities of users (e.g., hundreds, thousands, millions, etc.) in a single digital environment. The disclosed system solves this technical problem by providing a solution also rooted in computer technology, namely, by providing for scalable parallax system for rendering distant avatars, environments, and dynamic objects. The disclosed subject technology further provides improvements to the functioning of the computer itself because it improves processing and efficiency in rendering digital environments.

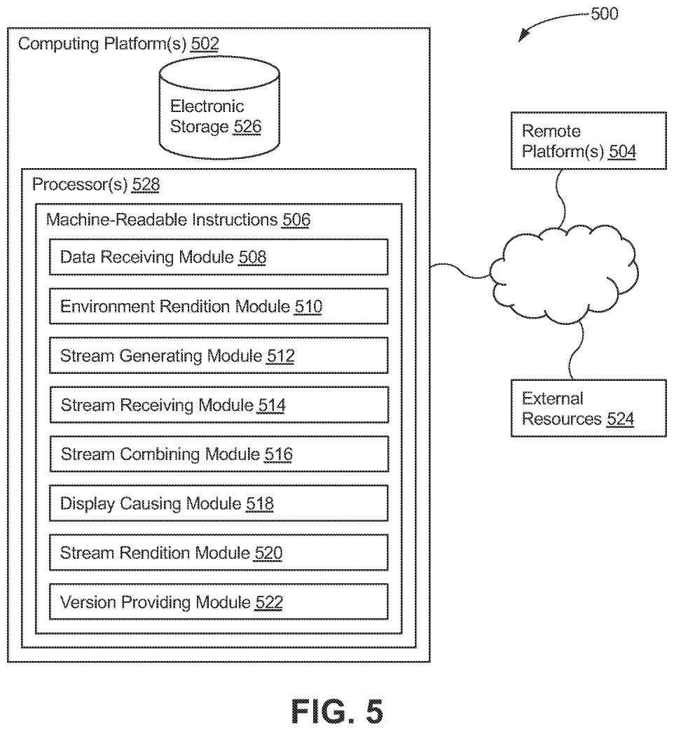

FIG. 5 illustrates a system 500 configured for rendering digital environments, according to certain aspects of the disclosure. In some implementations, system 500 may include one or more computing platforms 502. Computing platform(s) 502 may be configured to communicate with one or more remote platforms 504 according to a client/server architecture, a peer-to-peer architecture, and/or other architectures. Remote platform(s) 504 may be configured to communicate with other remote platforms via computing platform(s) 502 and/or according to a client/server architecture, a peer-to-peer architecture, and/or other architectures. Users may access system 500 via remote platform(s) 504.

Computing platform(s) 502 may be configured by machine-readable instructions 506. Machine-readable instructions 506 may include one or more instruction modules. The instruction modules may include computer program modules. The instruction modules may include one or more of data receiving module 508, environment rendition module 510, stream generating module 512, stream receiving module 514, stream combining module 516, display causing module 518, stream rendition module 520, version providing module 522, and/or other instruction modules.

Data receiving module 508 may be configured to receive a data stream (e.g., at the multiple area rendering servers 102 in FIGS. 1A and 1B). The data stream may include visual and audio data. By way of non-limiting example, the data stream (e.g., as received at the multiple area rendering servers 102 in FIGS. 1A and 1B) may include information related to one or more of a topography and/or morphology of a digital environment, position and/or movement information of digital objects within the digital environment, or position and/or movement information of avatars within the digital environment. Data receiving module 508 may be configured to render digital environments. The video and audio data may include visual and sound features perceivable by a given user within the digital environment.

Environment rendition module 510 may be configured to render (e.g., by the multiple area rendering servers 102 in FIGS. 1A and 1B) a global digital environment based at least in part on the received data stream. In some implementations, the global environment may include animated avatars and/or dynamic objects. In some implementations, the animated avatars may include digital representations of individual users that can move within the digital environment. In some implementations, the dynamic objects include non-avatar objects that can move and/or be moved within the digital environment. The global digital environment may include a stadium. The global digital environment may include a digital environment containing a plurality of local digital environments. Rendering the global digital environment may include providing a visual representation of the global digital environment viewed from a perspective of a given avatar. The global digital environment may include a representation of a real-world location in which a group of people can interact in a defined area and are prevented from interacting with other people in other defined areas containing other people. The group of people in the defined area can see the other people in the other defined areas.

Environment rendition module 510 may be configured to render, by one or more client platforms, a local digital environment based at least in part on the new parallax rendering data stream. The local digital environment may include a digital environment provided via a given client platform.

Stream generating module 512 may be configured to generate a parallax rendering data stream based at least in part on the received data stream. The parallax rendering data stream may include information related to an appearance of different parts of the global digital environment. A given parallax material may include information related to a visual appearance of a surface or region within the virtual environment.

Stream receiving module 514 may be configured to receive the parallax rendering data stream and/or an audio stream (e.g., at a composition server 104 of FIGS. 1A and 1B). The stream receiving module 514 configured to combine the parallax rendering data stream into a sequence of material atlases. Stream receiving module 514 may be configured to combine audio with the parallax rendering data stream into one or more spatialized audio streams.

Stream combining module 516 may be configured to combine (e.g., by the composition server 104 of FIGS. 1A and 1B) the received parallax rendering data stream into a new parallax rendering data stream. The new parallax rendering data stream may include a plurality of sequences and spatialized audio. A given sequence of the plurality of sequences may include visual frames that are presented sequentially to create a dynamic scene within the digital environment. The spatialized audio may include sound signals that are perceived differently for different avatars based on positions of individual avatars within the digital environment. The sequences may include material atlases. A given material atlas may include an image containing multiple smaller images. The multiple smaller images may be uniformly-sized images or images of varying dimensions. A given sub-image may be drawn using material coordinates of the material atlas. The sequence of material atlases may be accessible to one or more client computing platforms (e.g., remote platform(s) 504 and/or client platform(s) 114 in FIGS. 1A and 1B). In some implementations, a given client platforms may include a user device. The new parallax rendering data stream may include perspective-aware materials. Combining the received parallax rendering data stream into the new parallax rendering data stream may include rendering using a hybrid of local rendered imagery and cloud rendered imagery.

Display causing module 518 may be configured to cause display of the local digital environment through an output of the one or more client platforms. The output of a given client platform may include a presentation of the local digital environment from a virtual viewpoint of a user associated with given client platform. In some implementations, each visible area on the client platforms may have positional data in addition to other metadata that is sent to an area dispatcher service. In some implementations, the area dispatcher service may be configured to provide connection information for connecting to a correct area composition services to retrieve the parallax rendering data streams.

Stream rendition module 520 may be configured to render (e.g., by the multiple area rendering servers 102 in FIGS. 1A and 1B) an audio stream for the global digital environment. The audio stream for the global digital environment may include multiple audio streams associated with different locations within the global digital environment.

Version providing module 522 may be configured to provide multiple versions of the new parallax rendering data stream to one or more client platforms. A given version of the multiple versions of the new parallax rendering data stream may include a new parallax rendering data stream associated with a given location within the digital environment.

In some implementations, computing platform(s) 502, remote platform(s) 504, and/or external resources 524 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 502, remote platform(s) 504, and/or external resources 524 may be operatively linked via some other communication media.

A given remote platform 504 may include one or more processors configured to execute computer program modules. The computer program modules may be configured to enable an expert or user associated with the given remote platform 504 to interface with system 500 and/or external resources 524, and/or provide other functionality attributed herein to remote platform(s) 504. By way of non-limiting example, a given remote platform 504 and/or a given computing platform 502 may include one or more of a server, an artificial reality device and/or system, a desktop computer, a laptop computer, a handheld computer, a tablet computing platform, a NetBook, a Smartphone, a gaming console, and/or other computing platforms.

External resources 524 may include sources of information outside of system 500, external entities participating with system 500, and/or other resources. In some implementations, some or all of the functionality attributed herein to external resources 524 may be provided by resources included in system 500.

Computing platform(s) 502 may include electronic storage 526, one or more processors 528, and/or other components. Computing platform(s) 502 may include communication lines, or ports to enable the exchange of information with a network and/or other computing platforms. Illustration of computing platform(s) 502 in FIG. 5 is not intended to be limiting. Computing platform(s) 502 may include a plurality of hardware, software, and/or firmware components operating together to provide the functionality attributed herein to computing platform(s) 502. For example, computing platform(s) 502 may be implemented by a cloud of computing platforms operating together as computing platform(s) 502.

Electronic storage 526 may comprise non-transitory storage media that electronically stores information. The electronic storage media of electronic storage 526 may include one or both of system storage that is provided integrally (i.e., substantially non-removable) with computing platform(s) 502 and/or removable storage that is removably connectable to computing platform(s) 502 via, for example, a port (e.g., a USB port, a firewire port, etc.) or a drive (e.g., a disk drive, etc.). Electronic storage 526 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 526 may include one or more virtual storage resources (e.g., cloud storage, a virtual private network, and/or other virtual storage resources). Electronic storage 526 may store software algorithms, information determined by processor(s) 528, information received from computing platform(s) 502, information received from remote platform(s) 504, and/or other information that enables computing platform(s) 502 to function as described herein.

Processor(s) 528 may be configured to provide information processing capabilities in computing platform(s) 502. As such, processor(s) 528 may include one or more of a digital processor, an analog processor, a digital circuit designed to process information, an analog circuit designed to process information, a state machine, and/or other mechanisms for electronically processing information. Although processor(s) 528 is shown in FIG. 5 as a single entity, this is for illustrative purposes only. In some implementations, processor(s) 528 may include a plurality of processing units. These processing units may be physically located within the same device, or processor(s) 528 may represent processing functionality of a plurality of devices operating in coordination. Processor(s) 528 may be configured to execute modules 508, 510, 512, 514, 516, 518, 520, and/or 522, and/or other modules. Processor(s) 528 may be configured to execute modules 508, 510, 512, 514, 516, 518, 520, and/or 522, and/or other modules by software; hardware; firmware; some combination of software, hardware, and/or firmware; and/or other mechanisms for configuring processing capabilities on processor(s) 528. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 508, 510, 512, 514, 516, 518, 520, and/or 522 are illustrated in FIG. 5 as being implemented within a single processing unit, in implementations in which processor(s) 528 includes multiple processing units, one or more of modules 508, 510, 512, 514, 516, 518, 520, and/or 522 may be implemented remotely from the other modules. The description of the functionality provided by the different modules 508, 510, 512, 514, 516, 518, 520, and/or 522 described below is for illustrative purposes, and is not intended to be limiting, as any of modules 508, 510, 512, 514, 516, 518, 520, and/or 522 may provide more or less functionality than is described. For example, one or more of modules 508, 510, 512, 514, 516, 518, 520, and/or 522 may be eliminated, and some or all of its functionality may be provided by other ones of modules 508, 510, 512, 514, 516, 518, 520, and/or 522. As another example, processor(s) 528 may be configured to execute one or more additional modules that may perform some or all of the functionality attributed below to one of modules 508, 510, 512, 514, 516, 518, 520, and/or 522.

In particular embodiments, one or more objects (e.g., content or other types of objects) of a computing system may be associated with one or more privacy settings. The one or more objects may be stored on or otherwise associated with any suitable computing system or application, such as, for example, a social-networking system, a client system, a third-party system, a social-networking application, a messaging application, a photo-sharing application, or any other suitable computing system or application. Although the examples discussed herein are in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular embodiments, privacy settings for an object may specify a “blocked list” of users or other entities that should not be allowed to access certain information associated with the object. In particular embodiments, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular embodiments, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node corresponding to a particular photo may have a privacy setting specifying that the photo may be accessed only by users tagged in the photo and friends of the users tagged in the photo. In particular embodiments, privacy settings may allow users to opt in to or opt out of having their content, information, or actions stored/logged by the social-networking system or shared with other systems (e.g., a third-party system). Although this disclosure describes using particular privacy settings in a particular manner, this disclosure contemplates using any suitable privacy settings in any suitable manner.

In particular embodiments, privacy settings may be based on one or more nodes or edges of a social graph. A privacy setting may be specified for one or more edges or edge-types of the social graph, or with respect to one or more nodes, or node-types of the social graph. The privacy settings applied to a particular edge connecting two nodes may control whether the relationship between the two entities corresponding to the nodes is visible to other users of the online social network. Similarly, the privacy settings applied to a particular node may control whether the user or concept corresponding to the node is visible to other users of the online social network. As an example and not by way of limitation, a first user may share an object to the social-networking system. The object may be associated with a concept node connected to a user node of the first user by an edge. The first user may specify privacy settings that apply to a particular edge connecting to the concept node of the object, or may specify privacy settings that apply to all edges connecting to the concept node. As another example and not by way of limitation, the first user may share a set of objects of a particular object-type (e.g., a set of images). The first user may specify privacy settings with respect to all objects associated with the first user of that particular object-type as having a particular privacy setting (e.g., specifying that all images posted by the first user are visible only to friends of the first user and/or users tagged in the images).

In particular embodiments, the social-networking system may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular embodiments, the social-networking system may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular embodiments, one or more servers may be authorization/privacy servers for enforcing privacy settings. In response to a request from a user (or other entity) for a particular object stored in a data store, the social-networking system may send a request to the data store for the object. The request may identify the user associated with the request and the object may be sent only to the user (or a client system of the user) if the authorization server determines that the user is authorized to access the object based on the privacy settings associated with the object. If the requesting user is not authorized to access the object, the authorization server may prevent the requested object from being retrieved from the data store or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In particular embodiments, an object may represent content that is visible to a user through a newsfeed of the user. As an example and not by way of limitation, one or more objects may be visible to a user's “Trending” page. In particular embodiments, an object may correspond to a particular user. The object may be content associated with the particular user, or may be the particular user's account or information stored on the social-networking system, or other computing system. As an example and not by way of limitation, a first user may view one or more second users of an online social network through a “People You May Know” function of the online social network, or by viewing a list of friends of the first user. As an example and not by way of limitation, a first user may specify that they do not wish to see objects associated with a particular second user in their newsfeed or friends list. If the privacy settings for the object do not allow it to be surfaced to, discovered by, or visible to the user, the object may be excluded from the search results. Although this disclosure describes enforcing privacy settings in a particular manner, this disclosure contemplates enforcing privacy settings in any suitable manner.

In particular embodiments, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular embodiments, different privacy settings may be provided for different user groups or user demographics. As an example and not by way of limitation, a first user may specify that other users who attend the same university as the first user may view the first user's pictures, but that other users who are family members of the first user may not view those same pictures.

In particular embodiments, the social-networking system may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular embodiments, privacy settings may allow a first user to specify (e.g., by opting out, by not opting in) whether the social-networking system may receive, collect, log, or store particular objects or information associated with the user for any purpose. In particular embodiments, privacy settings may allow the first user to specify whether particular applications or processes may access, store, or use particular objects or information associated with the user. The privacy settings may allow the first user to opt in or opt out of having objects or information accessed, stored, or used by specific applications or processes. The social-networking system may access such information in order to provide a particular function or service to the first user, without the social-networking system having access to that information for any other purposes. Before accessing, storing, or using such objects or information, the social-networking system may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the social-networking system.

In particular embodiments, a user may specify whether particular types of objects or information associated with the first user may be accessed, stored, or used by the social-networking system. As an example and not by way of limitation, the first user may specify that images sent by the first user through the social-networking system may not be stored by the social-networking system. As another example and not by way of limitation, a first user may specify that messages sent from the first user to a particular second user may not be stored by the social-networking system. As yet another example and not by way of limitation, a first user may specify that all objects sent via a particular application may be saved by the social-networking system.

In particular embodiments, privacy settings may allow a first user to specify whether particular objects or information associated with the first user may be accessed from particular client systems or third-party systems. The privacy settings may allow the first user to opt in or opt out of having objects or information accessed from a particular device (e.g., the phone book on a user's smart phone), from a particular application (e.g., a messaging app), or from a particular system (e.g., an email server). The social-networking system may provide default privacy settings with respect to each device, system, or application, and/or the first user may be prompted to specify a particular privacy setting for each context. As an example and not by way of limitation, the first user may utilize a location-services feature of the social-networking system to provide recommendations for restaurants or other places in proximity to the user. The first user's default privacy settings may specify that the social-networking system may use location information provided from a client device of the first user to provide the location-based services, but that the social-networking system may not store the location information of the first user or provide it to any third-party system. The first user may then update the privacy settings to allow location information to be used by a third-party image-sharing application in order to geo-tag photos.

In particular embodiments, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular embodiments, changes to privacy settings may take effect retroactively, affecting the visibility of objects and content shared prior to the change. As an example and not by way of limitation, a first user may share a first image and specify that the first image is to be public to all other users. At a later time, the first user may specify that any images shared by the first user should be made visible only to a first user group. The social-networking system may determine that this privacy setting also applies to the first image and make the first image visible only to the first user group. In particular embodiments, the change in privacy settings may take effect only going forward. Continuing the example above, if the first user changes privacy settings and then shares a second image, the second image may be visible only to the first user group, but the first image may remain visible to all users. In particular embodiments, in response to a user action to change a privacy setting, the social-networking system may further prompt the user to indicate whether the user wants to apply the changes to the privacy setting retroactively. In particular embodiments, a user change to privacy settings may be a one-off change specific to one object. In particular embodiments, a user change to privacy may be a global change for all objects associated with the user.

In particular embodiments, the social-networking system may determine that a first user may want to change one or more privacy settings in response to a trigger action associated with the first user. The trigger action may be any suitable action on the online social network. As an example and not by way of limitation, a trigger action may be a change in the relationship between a first and second user of the online social network (e.g., “un-friending” a user, changing the relationship status between the users). In particular embodiments, upon determining that a trigger action has occurred, the social-networking system may prompt the first user to change the privacy settings regarding the visibility of objects associated with the first user. The prompt may redirect the first user to a workflow process for editing privacy settings with respect to one or more entities associated with the trigger action. The privacy settings associated with the first user may be changed only in response to an explicit input from the first user, and may not be changed without the approval of the first user. As an example and not by way of limitation, the workflow process may include providing the first user with the current privacy settings with respect to the second user or to a group of users (e.g., un-tagging the first user or second user from particular objects, changing the visibility of particular objects with respect to the second user or group of users), and receiving an indication from the first user to change the privacy settings based on any of the methods described herein, or to keep the existing privacy settings.

In particular embodiments, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example and not by way of limitation, a user's default privacy settings may indicate that a person's relationship status is visible to all users (i.e., “public”). However, if the user changes his or her relationship status, the social-networking system may determine that such action may be sensitive and may prompt the user to confirm that his or her relationship status should remain public before proceeding. As another example and not by way of limitation, a user's privacy settings may specify that the user's posts are visible only to friends of the user. However, if the user changes the privacy setting for his or her posts to being public, the social-networking system may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular embodiments, a user may need to provide verification of a privacy setting on a periodic basis. A prompt or reminder may be periodically sent to the user based either on time elapsed or a number of user actions. As an example and not by way of limitation, the social-networking system may send a reminder to the user to confirm his or her privacy settings every six months or after every ten photo posts. In particular embodiments, privacy settings may also allow users to control access to the objects or information on a per-request basis. As an example and not by way of limitation, the social-networking system may notify the user whenever a third-party system attempts to access information associated with the user, and require the user to provide verification that access should be allowed before proceeding.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

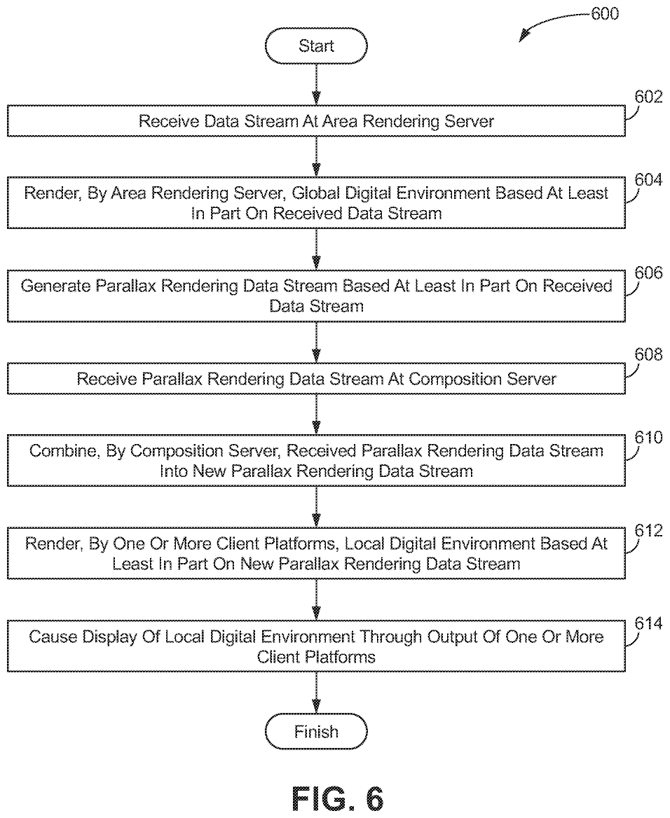

FIG. 6 illustrates an example flow diagram (e.g., process 600) for rendering digital environments, according to certain aspects of the disclosure. For explanatory purposes, the example process 600 is described herein with reference to FIGS. 1-5. Further for explanatory purposes, the steps of the example process 600 are described herein as occurring in serial, or linearly. However, multiple instances of the example process 600 may occur in parallel. For purposes of explanation of the subject technology, the process 600 will be discussed in reference to FIGS. 1-5.

At step 602, the process 600 may include receiving a data stream at an area rendering server. At step 604, the process 600 may include rendering, by the area rendering server, a global digital environment based at least in part on the received data stream. At step 606, the process 600 may include generating a parallax rendering data stream based at least in part on the received data stream. At step 608, the process 600 may include receiving the parallax rendering data stream at a composition server. At step 610, the process 600 may include combining, by the composition server, the received parallax rendering data stream into a new parallax rendering data stream. At step 612, the process 600 may include rendering, by one or more client platforms, a local digital environment based at least in part on the new parallax rendering data stream. At step 614, the process 600 may include causing display of the local digital environment through an output of the one or more client platforms.

For example, as described above in relation to FIGS. 1-5, at step 602, the process 600 may include receiving a data stream at an area rendering server, through data receiving module 508. At step 604, the process 600 may include rendering, by the area rendering server, a global digital environment based at least in part on the received data stream, through environment rendition module 510. At step 606, the process 600 may include generating a parallax rendering data stream based at least in part on the received data stream, through stream generating module 512. At step 608, the process 600 may include receiving the parallax rendering data stream at a composition server, through stream receiving module 514. At step 610, the process 600 may include combining, by the composition server, the received parallax rendering data stream into a new parallax rendering data stream, through stream combining module 516. At step 612, the process 600 may include rendering, by one or more client platforms, a local digital environment based at least in part on the new parallax rendering data stream, through environment rendition module 510. At step 614, the process 600 may include causing display of the local digital environment through an output of the one or more client platforms, through display causing module 518.

According to an aspect, the data stream comprises visual and audio data.

According to an aspect, the global environment comprises animated avatars and/or dynamic objects.

According to an aspect, the new parallax rendering data stream comprises a plurality of sequences and spatialized audio.

According to an aspect, the sequences comprise material atlases.

According to an aspect, the process 600 may include rendering, by the area rendering server, an audio stream for the global digital environment.

According to an aspect, the process 600 may include providing multiple versions of the new parallax rendering data stream to one or more client platforms.

According to an aspect, each visible area on the client platforms has positional data in addition to other metadata that is sent to an area dispatcher service, the area dispatcher service being configured to provide connection information for connecting to a correct area composition service to retrieve the parallax rendering data streams.

According to an aspect, the global digital environment comprises a stadium.

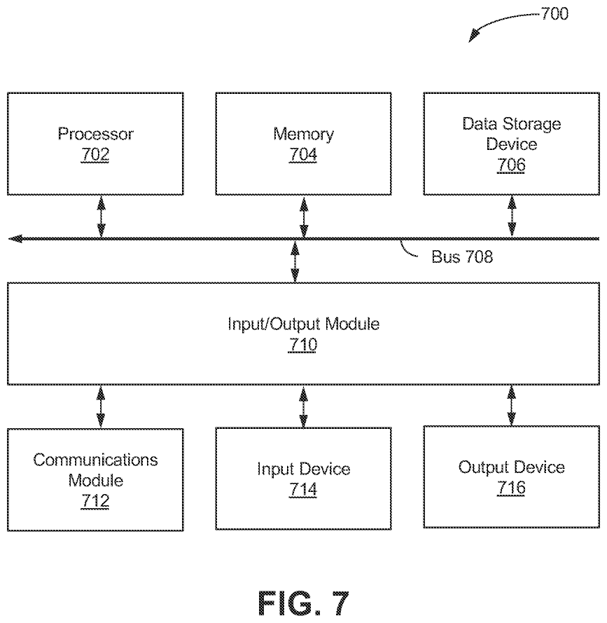

FIG. 7 is a block diagram illustrating an exemplary computer system 700 with which aspects of the subject technology can be implemented. In certain aspects, the computer system 700 may be implemented using hardware or a combination of software and hardware, either in a dedicated server, integrated into another entity, or distributed across multiple entities.

Computer system 700 (e.g., server and/or client) includes a bus 708 or other communication mechanism for communicating information, and a processor 702 coupled with bus 708 for processing information. By way of example, the computer system 700 may be implemented with one or more processors 702. Processor 702 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 700 can include, in addition to hardware, code that creates an execution environment for the computer program in question, e.g., code that constitutes processor firmware, a protocol stack, a database management system, an operating system, or a combination of one or more of them stored in an included memory 704, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 708 for storing information and instructions to be executed by processor 702. The processor 702 and the memory 704 can be supplemented by, or incorporated in, special purpose logic circuitry.

The instructions may be stored in the memory 704 and implemented in one or more computer program products, i.e., one or more modules of computer program instructions encoded on a computer-readable medium for execution by, or to control the operation of, the computer system 700, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 704 may also be used for storing temporary variable or other intermediate information during execution of instructions to be executed by processor 702.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 700 further includes a data storage device 706 such as a magnetic disk or optical disk, coupled to bus 708 for storing information and instructions. Computer system 700 may be coupled via input/output module 710 to various devices. The input/output module 710 can be any input/output module. Exemplary input/output modules 710 include data ports such as USB ports. The input/output module 710 is configured to connect to a communications module 712. Exemplary communications modules 712 include networking interface cards, such as Ethernet cards and modems. In certain aspects, the input/output module 710 is configured to connect to a plurality of devices, such as an input device 714 and/or an output device 716. Exemplary input devices 714 include a keyboard and a pointing device, e.g., a mouse or a trackball, by which a user can provide input to the computer system 700. Other kinds of input devices 714 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 716 include display devices such as an LCD (liquid crystal display) monitor, for displaying information to the user.

According to one aspect of the present disclosure, the above-described gaming systems can be implemented using a computer system 700 in response to processor 702 executing one or more sequences of one or more instructions contained in memory 704. Such instructions may be read into memory 704 from another machine-readable medium, such as data storage device 706. Execution of the sequences of instructions contained in the main memory 704 causes processor 702 to perform the process steps described herein. One or more processors in a multi-processing arrangement may also be employed to execute the sequences of instructions contained in memory 704. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 700 can include clients and servers. A client and server are generally remote from each other and typically interact through a communication network. The relationship of client and server arises by virtue of computer programs running on the respective computers and having a client-server relationship to each other. Computer system 700 can be, for example, and without limitation, a desktop computer, laptop computer, or tablet computer. Computer system 700 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 702 for execution. Such a medium may take many forms, including, but not limited to, non-volatile media, volatile media, and transmission media. Non-volatile media include, for example, optical or magnetic disks, such as data storage device 706. Volatile media include dynamic memory, such as memory 704. Transmission media include coaxial cables, copper wire, and fiber optics, including the wires that comprise bus 708. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 700 reads game data and provides a game, information may be read from the game data and stored in a memory device, such as the memory 704. Additionally, data from the memory 704 servers accessed via a network the bus 708, or the data storage 706 may be read and loaded into the memory 704. Although data is described as being found in the memory 704, it will be understood that data does not have to be stored in the memory 704 and may be stored in other memory accessible to the processor 702 or distributed among several media, such as the data storage 706.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method for rendering digital environments, the method comprising:
receiving a data stream at an area rendering server;
rendering, by the area rendering server, a global digital environment based at least in part on the received data stream;
generating a parallax rendering data stream based at least in part on the received data stream;
receiving the parallax rendering data stream at a composition server;
combining, by the composition server, the received parallax rendering data stream into a new parallax rendering data stream;
rendering, by one or more client platforms, a local digital environment based at least in part on the new parallax rendering data stream; and
causing display of the local digital environment through an output of the one or more client platforms.

2. The method of claim 1, wherein the data stream comprises visual and audio data.

3. The method of claim 1, wherein the global environment comprises animated avatars and/or dynamic objects.

4. The method of claim 1, wherein the new parallax rendering data stream comprises a plurality of sequences and spatialized audio.

5. The method of claim 4, wherein the sequences comprise material atlases.

6. The method of claim 1, further comprising:
rendering, by the area rendering server, an audio stream for the global digital environment.

7. The method of claim 1, further comprising:
providing multiple versions of the new parallax rendering data stream to one or more client platforms.

8. The method of claim 1, wherein each visible area on the client platforms has positional data in addition to other metadata that is sent to an area dispatcher service, the area dispatcher service being configured to provide connection information for connecting to a correct area composition services to retrieve the parallax rendering data streams.

9. The method of claim 1, wherein the global digital environment comprises a stadium.

10. The method of claim 1, wherein the data stream received at the area rendering server includes information related to one or more of a topography and/or morphology of a digital environment, position and/or movement information of digital objects within the digital environment, or position and/or movement information of avatars within the digital environment.

11. A system configured for rendering digital environments, the system comprising:
one or more hardware processors configured by machine-readable instructions to:
receive a data stream at an area rendering server;
render, by the area rendering server, a global digital environment based at least in part on the received data stream, wherein the global environment comprises animated avatars and/or dynamic objects;
generate a parallax rendering data stream based at least in part on the received data stream;
render, by the area rendering server, an audio stream for the global digital environment;
receive the parallax rendering data stream and the audio stream at a composition server;
combine, by the composition server, the received parallax rendering data stream and the audio stream into a new parallax rendering data stream;
render, by one or more client platforms, a local digital environment based at least in part on the new parallax rendering data stream; and
cause display of the local digital environment through an output of the one or more client platforms.

12. The system of claim 11, wherein the data stream comprises visual and audio data.

13. The system of claim 11, wherein the global digital environment includes a digital environment containing a plurality of local digital environments.

14. The system of claim 11, wherein the new parallax rendering data stream comprises a plurality of sequences and spatialized audio.

15. The system of claim 14, wherein the sequences comprise material atlases.

16. The system of claim 11, wherein the one or more hardware processors are further configured by machine-readable instructions to:
combine the parallax rendering data stream into a sequence of material atlases.

17. The system of claim 11, wherein the data stream received at the area rendering server includes information related to one or more of a topography and/or morphology of a digital environment, position and/or movement information of digital objects within the digital environment, or position and/or movement information of avatars within the digital environment.

18. The system of claim 11, wherein each visible area on the client platforms has positional data in addition to other metadata that is sent to an area dispatcher service, the area dispatcher service being configured to provide connection information for connecting to a correct area composition services to retrieve the parallax rendering data streams, and wherein the global digital environment comprises a stadium.

19. The system of claim 11, wherein the data stream received at the area rendering server includes information related to one or more of a topography and/or morphology of a digital environment, position and/or movement information of digital objects within the digital environment, or position and/or movement information of avatars within the digital environment.

20. A non-transient computer-readable storage medium having instructions embodied thereon, the instructions being executable by one or more processors to perform a method for rendering digital environments, the method comprising:
receiving a data stream at an area rendering server;
rendering, by the area rendering server, a global digital environment based at least in part on the received data stream, wherein the global digital environment comprises a stadium, and wherein the global environment comprises animated avatars and/or dynamic objects;
generating a parallax rendering data stream based at least in part on the received data stream;
rendering, by the area rendering server, an audio stream for the global digital environment;
receiving the parallax rendering data stream and the audio stream at a composition server;
combining, by the composition server, the received parallax rendering data stream and audio stream into a new parallax rendering data stream;
providing multiple versions of the new parallax rendering data stream to one or more client platforms;
rendering, by the one or more client platforms, a local digital environment based at least in part on the new parallax rendering data stream; and
causing display of the local digital environment through an output of the one or more client platforms.
